(19) United States
(12) Patent Application Publication
(10) Pub. No.: US 2026/0110900 A1
(43) Pub. Date: Apr. 23, 2026

(54) REFLECTIVE DISPLAY ON THE EDGE OF A WINDSHIELD

(71) Applicant: HARMAN INTERNATIONAL INDUSTRIES, INCORPORATED, Stamford, CT (US)

(72) Inventors: Daehyoun BYOUN, Seoul (KR); Kugjin CHO, Seoul (KR); Jeseung OH, Suwon city (KR); Haewon YOU, Suwon city (KR)

(21) Appl. No.: 19/114,988

(22) PCT Filed: Oct. 4, 2023
(86) PCT No.: PCT/US2023/034478

§ 371 Date: Mar. 25, 2025

Related U.S. Application Data
(60) Provisional application No. 63/414,419, filed on Oct. 7, 2022.

(51) Int. Cl. G02B 27/01; B60K 35/23; H04N 9/31

(52) U.S. Cl. CPC G02B 27/0101; B60K 35/23; H04N 9/3173; H04N 9/3185; B60K 2360/25; H04N 9/3182

(57) ABSTRACT

Embodiments of the present disclosure set forth techniques for displaying content in a projection display system. A computer-implemented method includes receiving data associated with a vehicle; generating, based on the received data, content for display on a projection surface comprising a partially absorptive portion and a transparent portion, wherein the partially absorptive portion is located along one or more border regions of the projection surface and the transparent portion is located in a central region of the projection surface; and projecting the content onto the partially absorptive portion of the projection surface.

### CROSS-REFERENCE TO RELATED APPLICATIONS

This application claims priority benefit of the U.S. Provisional Patent Application titled, “REFLECTIVE DISPLAY ON THE EDGE OF A WINDSHIELD,” filed on Oct. 7, 2022, and having Ser. No. 63/414,419. The subject matter of this related application is hereby incorporated herein by reference.

### BACKGROUND

### Field of the Various Embodiments

The various embodiments relate generally to in-vehicle display systems, and more specifically, to a reflective display on the edge of a windshield.

### Description of the Related Art

Many modern vehicles rely on sophisticated electronics systems for various operational and safety functions, including engine performance, information, and entertainment (also referred to as infotainment), autonomous or semiautonomous driving, collision avoidance, route navigation, and/or the like. A vehicle can be equipped with a console display system for presenting information to an occupant (e.g., a driver, an operator, a passenger) of the vehicle. The console display system presents information on a console display or an instrument panel that can be mounted on the center console of the vehicle. The occupant can access various functions by interacting with the console display system, such as by activating pushbuttons and rotational controls adjacent to the console display, touching various areas of a touchscreen of the console display, and/or the like.

One problem with such a console display system is that, when the driver of the vehicle interacts with the console display system, the driver momentarily focuses their attention away from the road ahead and towards the console display. Subsequent to interacting with the console display, the driver focuses their attention away from the console display and returns focus towards the road. In one example, when the driver focuses on the road ahead, the driver may be focusing on a region that is approximately 2 to 3 degrees below the horizontal plane of the eyes of the driver and at a distance that can range as far as 200 to 400 meters ahead of the vehicle. By contrast, when the driver focuses on the console display, the driver may be focusing on a region that is approximately 16 to 18 degrees below the horizontal plane of the eyes of the driver and at a distance that can range from 30 to 40 centimeters from the eye of the driver. This difference in viewing angle and distance can momentarily cause the driver to not see certain objects, such as other vehicles, traffic lights, pedestrians, and/or the like. As a result, the driver can be distracted, which can lead to an increased potential for traffic accidents.

One approach for mitigating distraction associated with console displays is to equip the vehicle with a heads-up display system for presenting information to an occupant of the vehicle. In a heads-up display system, content is typically projected onto a transparent object (e.g., a windshield of the vehicle, a transparent display positioned between the occupant and the windshield), and the content reflects from the transparent object toward the occupant. The heads-up display system presents information in a way that allows the occupant to continue looking forward, toward the environment in front of the vehicle, without needing to look down toward the console display. Vehicles of different types can implement a heads-up display to facilitate maintained attention by a vehicle operator on the environment in front of the vehicle.

A drawback of a heads-up display system is that the system can present a ghost image of content projected by the system, as well as the intended virtual image of the projected content. The ghost image is a consequence of the projected content reflecting from multiple surfaces of the transparent object (e.g., inner and outer layers of a windshield) toward the occupant, resulting in the intended virtual image and the ghost image of the content arriving at the eyes of the user at different angles relative to the transparent object. The ghost image can be a distraction for the occupant trying to view the projected content and/or makes the head-up display less effective at conveying information to the occupant. Another drawback of heads-up display systems is that such display systems can require a significant amount of power to generate projected content that is bright enough to be seen and understood by the occupant. The amount of power to support a heads-up display can be significant enough to affect the range of the vehicle, such as by reducing the miles per gallon (MPG) of a fuel-powered vehicle, reducing the miles per gallon equivalent (MPGe) of an electric vehicle, and/or the like.

As the foregoing illustrates, what is needed is a more effective way to present content to an occupant of a vehicle.

### SUMMARY

One embodiment sets forth a computer-implemented method comprising receiving data associated with a vehicle; generating, based on the received data, content for display on a projection surface comprising a partially absorptive portion and a transparent portion, wherein the partially absorptive portion is located along one or more border regions of the projection surface and the transparent portion is located in a central region of the projection surface; and projecting the content onto the partially absorptive portion of the projection surface.

One embodiment sets forth a system comprising a projection surface comprising a partially absorptive portion and a transparent portion; and a first projection unit. The first projection unit is configured to: receive data associated with a vehicle; generate, based on the received data, content for display on a projection surface comprising a partially absorptive portion and a transparent portion, wherein the partially absorptive portion is located along one or more border regions of the projection surface and the transparent portion is located in a central region of the projection surface; and project the content onto the partially absorptive portion of the projection surface.

Further embodiments provide, among other things, one or more non-transitory computer-readable media and systems configured to implement the method set forth above.

At least one technical advantage of the disclosed approaches relative to the prior art is that, with the disclosed techniques, the angle and distance between the view of the road ahead and the view of displayed content is reduced relative to conventional systems that present content on a console display. As a result, the level of distraction experienced by an occupant when viewing the displayed content is reduced relative to systems with console displays. Another advantage of the disclosed approaches relative to the prior art is that the amount of power needed to project content for display on a partially absorptive surface of the windshield is reduced relative to heads-up display systems, leading to improved mileage performance. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a projection display system configured to implement one or more aspects of the various embodiments;

FIG. 2 illustrates a content display arrangement implemented in a vehicle with the projection display system of FIG. 1, according to various embodiments;

FIG. 3 illustrates display arrangements associated with the projection units of FIG. 1, according to various embodiments;

FIG. 4 illustrates content displayed on one or more portions of a projection surface by the projection units of FIG. 1, according to various embodiments;

FIG. 5 illustrates content displayed on one or more portions of a projection surface by the projection units of FIG. 1, according to various other embodiments;

FIG. 6 illustrates a graph of transmittance and reflectance characteristics of S-state polarized light and P-state polarized light, according to various other embodiments;

FIG. 7 illustrates curvature of a windshield that includes a frit region, according to various other embodiments;

FIG. 8 illustrates modification of content to compensate for curvature of the windshield of FIG. 7, according to various other embodiments; and

FIG. 9 is a flow diagram of method steps for displaying content via the projection display system of FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

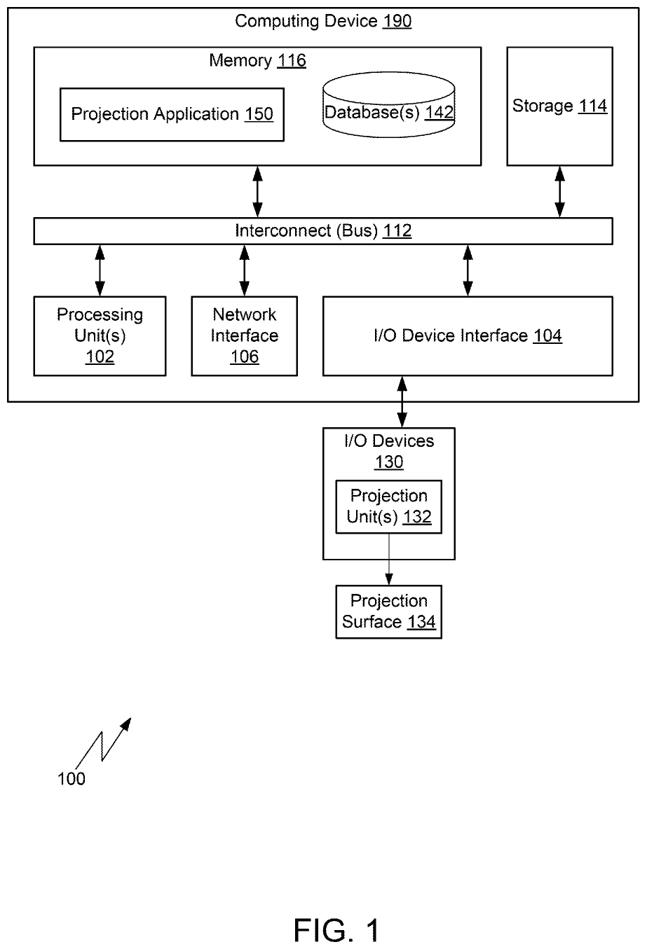

FIG. 1 is a block diagram of a projection display system 100 configured to implement one or more aspects of the various embodiments. As shown, projection display system 100 includes, without limitation, computing device 190, input/output (I/O) device(s) 130, and a projection surface 134. Computing device 190 includes, without limitation, one or more processing units 102, I/O device interface 104, network interface 106, interconnect (bus) 112, storage 114, and memory 116. Memory 116 stores database(s) 142 and projection application 150. Processing unit(s) 102, I/O device interface 104, network interface 106, storage 114, and memory 116 can be communicatively coupled to each other via interconnect 112. In various embodiments, projection display system 100 can display content to a user (e.g., a vehicle driver or operator) by projecting images of text, graphics, icons, etc. corresponding to the content onto projection surface 134, which redirects the projected images toward the user.

As noted above, computing device 190 can include processing unit(s) 102 and memory 116. Computing device 190 can be a system-on-a-chip (SoC). In various embodiments, computing device 190 can be a head unit included in a vehicle system. In some embodiments, computing device 190, or projection display system 100 overall, can be an aftermarket system or device added to a vehicle. Generally, computing device 190 can be configured to coordinate the overall operation of projection display system 100. The embodiments disclosed herein contemplate any technically feasible system configured to implement the functionality of projection display system 100 via computing device 190. Various examples of computing device 190 include wearable devices (e.g., helmet, headset, glasses, etc.), vehicle computing devices (e.g., head units, in-vehicle infotainment systems, driver assistance systems, aftermarket systems), and/or the like.

Processing unit(s) 102 can include a central processing unit (CPU), a digital signal processing unit (DSP), a microprocessor, an application-specific integrated circuit (ASIC), a neural processing unit (NPU), a graphics processing unit (GPU), a field-programmable gate array (FPGA), and/or the like. Each processing unit 102 generally comprises a programmable processor that executes program instructions to manipulate input data. In some embodiments, processing unit(s) 102 can include any number of processing cores, memories, and/or other modules for facilitating program execution. In some embodiments, processing unit(s) 102 can be configured to execute projection application 150 to provide display services. In some embodiments, projection application 150 can generate images containing content based on information from various sources associated with a vehicle (e.g., navigation system, infotainment system, driver assistance system, and/or the like) and can cause the content images to be displayed via the projection display system 100 of the vehicle.

Storage 114 can include non-volatile storage for applications, software modules, and data, and can include fixed or removable disk drives, flash memory devices, and CD-ROM, DVD-ROM, Blu-Ray, HD-DVD, or other magnetic, optical, solid state storage devices, and/or the like. For example, projection application 150 and database(s) 142 could be stored in storage 114, and then loaded into memory 116 as needed.

Memory 116 can include a memory module or collection of memory modules. Memory 116 generally comprises storage chips such as random access memory (RAM) chips that store application programs and data for processing by processing unit 102. Processing unit(s) 102, I/O device interface 104, and network interface 106 can be configured to read data from and write data to memory 116. Projection application 150 can be loaded from storage 114 into memory 116. While in memory 116, projection application 150 can be executed by processing unit(s) 102 to implement the functionality described according to the various embodiments in the present disclosure.

Database(s) 142 can store templates, display elements (e.g., textual characters, graphics, shapes, etc.) and/or palettes of display elements, etc. usable by processing unit(s) 102 to generate images for display via projection display system 100 and projection application 150. That is, database(s) 142 can include one or more repositories of templates, display elements, display element palettes, and/or the like. Database(s) 142 or portions thereof can be stored in storage 114 and loaded into memory 116 as needed. In various embodiments, processing unit(s) 102 can be configured to retrieve templates and/or display elements stored in database(s) 142 to generate images for display. For example, database(s) 142 could store templates, formats, or the like for displaying navigation information via projection display system 100, and display elements usable for displaying navigation information (e.g., alphanumeric characters, symbols, icons, graphics, etc.). Projection application 150 can retrieve these templates and elements and generate images that include the display elements arranged based on the template to present navigation information. In some embodiments, database(s) 142 may receive periodic updates for at least a portion of the data stored in database(s) 142 (e.g., additional and/or updated fonts for characters, additional and/or updated symbols, additional and/or updated graphics, display elements for additional and/or updated languages, etc.) from a remote computing system (e.g., a cloud computing system or a remote server system) via network interface 106 and a wired or wireless network (not shown). In some embodiments, display elements stored in databases 142 include one or more of fonts for textual characters, fonts for one or more languages, shapes, icons, graphics, and/or the like. In some embodiments, templates stored in databases 142 include templates for arranging and displaying one or more of: navigation information, vehicle speed information, infotainment media information (media playback information), vehicle state or status information, environmental information (e.g., weather), and/or the like.

In some embodiments, projection display system 100 can be coupled to a sensor array (not shown), which can include one or more sensor devices that perform measurements and/or acquire data related to certain subjects in an environment. Sensor array can include an outward sensor array and/or an inward sensor array. The outward sensor array can include one or more sensor devices configured to perform measurements and/or acquire data related to the exterior of the vehicle (e.g., environment around the vehicle). The inward sensor array can include one or more sensor devices configured to perform measurements and/or acquire data related to the interior of the vehicle (e.g., vehicle cabin, vehicle occupants). Examples of sensor devices include, without limitation, biometric sensors, physiological sensors, imaging sensors, acoustic sensors, environmental sensors, behavioral sensors, imagers, laser sensors, ultrasound sensors, radar sensors, LIDAR sensor, physical sensors (e.g., touch sensors, pressure sensors, position sensors, an accelerometer, an inertial measurement unit (IMU)), motion sensors, etc. The sensor array can generate sensor data associated with a state and/or context of a vehicle, one or more occupants (e.g., driver, passenger) of the vehicle, and/or the environment around the vehicle. For example, the sensor array could collect biometric data related to the driver (e.g., heart rate, brain activity, skin conductance, blood oxygenation, pupil size, eye motion, galvanic skin response, blood-pressure level, average blood glucose concentration, etc.). Additionally or alternatively, the sensor array can generate sensor data associated with a cabin of the vehicle. For example, the sensor array could generate sensor data about the presence of other occupants in the vehicle, the environment within the cabin of the vehicle, operation of the vehicle, and so forth. Further additionally or alternatively, the sensor array can generate sensor data associated with an environment outside of the vehicle. For example, the sensor array could generate sensor data about the weather outside of the vehicle (e.g., outside temperature), detection of objects in proximity of the vehicle (e.g., other vehicles, people, animals, etc.), detection of road features (e.g., lane markers, road signs, etc.), and so forth. More generally, the sensor array can be a source of information for which projection display system 100 can generate images for display. For example, a driver assistance system can process sensor data obtained from the sensor array to generate information, which is passed on to projection application 150. Projection application 150 can generate images containing content that presents the information obtained from the driver assistance system.

I/O device(s) 130 can include devices capable of receiving input (not shown) (e.g., a keyboard, a mouse, a touch-sensitive screen, pushbuttons, rotary knobs, a microphone, etc.) for providing input data to computing device 190. I/O device(s) 130 can include devices capable of providing output (e.g., a display screen, one or more speakers, haptic devices, touchless haptic devices, and/or the like. One or more of I/O devices 130 can be incorporated in computing device 190 or can be external to computing device 190. I/O devices 130 can interface with computing device 190 via I/O devices interface 104. In some embodiments, computing device 190 and/or one or more I/O device(s) 130 can be components of a head unit implemented in a vehicle. In some embodiments, projection application 150 can obtain information from one or more systems and/or sub-systems of the vehicle (e.g., navigation system, infotainment system, driver assistance system) and display that information via projection display system 100. More generally, projection display system 100 (e.g., computing device 190) can interface with other systems of the vehicle to acquire information for display.

A network (not shown) can enable communications between computing device 190 and other devices in network via wired and/or wireless communications protocols, satellite networks, telephone networks, V2X networks, including Bluetooth, Bluetooth low energy (BLE), wireless local area network (WiFi), cellular protocols, and/or near-field communications (NFC). The network can be any technically feasible type of communications network that allows data to be exchanged between computing device 190 and remote systems or devices, such as a server, a cloud computing system, cloud-based storage, or other networked computing device or system. For example, the network could include a wide area network (WAN), a local area network (LAN), a wireless network (e.g., a Wi-Fi network, a cellular data network), and/or the Internet, among others. Computing device 190 can connect with a network via network interface 106. In some embodiments, network interface 106 is hardware, software, or a combination of hardware and software, which is configured to connect to and interface with one or more networks.

In some embodiments, projection display system 100 can include or be coupled to a location module. A location module can include hardware and/or software components for determining a geographic location of computing device 190 (e.g., a current location of the vehicle). The location module can determine a location of computing device 190 via acquisition of geolocation data (e.g., from a global navigation satellite system, such as a global positioning system (GPS), Glonass, Galileo, Beidou, etc.) and/or determination of location based on sensor data from a sensor array (e.g., dead reckoning). The location module can also cross-reference an acquired and/or determined geographic location with a navigation database, which can be stored in database(s) 142, to determine address information corresponding to the geographic location.

In some embodiments, computing device 190 can pair and communicate with another computing device in proximity. That another computing device can couple to computing device 190 via I/O device interface 104, and/or network interface 106 and one or more networks, using any suitable wired (e.g., USB cable) or wireless (e.g., Bluetooth, Wi-Fi) connection. Projection application 150 on computing device 190 can communicate and interface with applications on that another computing device. For example, projection application 150 can communicate and interface with a navigation application on that another computing device to obtain navigation information, which projection application 150 can then use to generate images for display.

In various embodiments, I/O devices 130 include one or more projection units 132. Projection unit(s) 132 can project images onto projection surface 134. In particular, projection unit(s) 132 can project images whose propagating light beams reflect off a surface of projection surface 134 toward a user (e.g., a vehicle occupant). In some embodiments, projection unit(s) 132 is an optical collimator. More generally, projection unit(s) 132 can be any technically feasible projection device suitable for projecting images onto a partially absorptive surface. In some embodiments, projection unit(s) 132 is positioned under projection surface 134 and projects images upward toward projection surface 134. In some embodiments, projection unit(s) 132 can include one or more optical devices (e.g., lens, prisms, mirrors, or the like, or any combination thereof) that can affect a virtual image distance of images projected by projection unit(s) 132. In some embodiments, projection unit(s) 132 can include an actuator or the like that can orient or reorient projection unit(s) 132 or a component thereof (e.g., one or more optical devices in projection unit(s) 132 in order to affect an angle of projection of images from projection unit(s) 132, and correspondingly affect an angle of incidence onto projection surface 134.

Projection surface 134 can be one or more pieces of glass, plastic, or the like that can redirect, by reflection, images projected from projection unit(s) 132 toward a vehicle occupant. In some embodiments, projection surface 134 can include a transparent portion that can allow light to pass through and a partially absorptive portion that can partially absorb light that penetrates an inner surface of projection surface 134, while a portion of the light reflects off the inner surface and toward a vehicle occupant. In some embodiments, projection surface 134 can be a windshield of the vehicle. In such embodiments, the transparent portion can be located in the central region of the windshield. The partially absorptive portion can be a frit region located along one or more border regions, or edges, of the windshield, such as the upper windshield border region, the lower windshield border region, the right windshield border region, the left windshield border region, and/or the like. The frit region can include a solid portion located along one or more border regions of the windshield. Additionally or alternatively, the frit region can include a pattern portion, where the patterned portion includes an array of shapes of various sizes, such as circular shapes, hexagonal shapes, elliptical shapes, and/or the like. The frit region can be colored black and can be composed of ceramic paint, enamel paint, and/or the like. The frit region serves various functions, such as helping adhesives bond the windshield to the vehicle, reduces the amount of exterior ultraviolet radiation from the sun that enters the interior of the vehicle, reducing sunlight glare, dissipating heat, providing an aesthetically pleasing look, and/or the like. As described herein, the frit region absorbs, or partially absorbs, light beams that penetrate the inner surface of the windshield. Such light beams could otherwise refract in the windshield, reflect off the outer surface of the windshield, and cause the user to perceive ghost images of displayed content. Such ghost images can reduce the legibility of images projected onto the windshield. Instead, the frit region absorbs, or partially absorbs, the refracted light beams, thereby reducing or eliminating such ghost images.

In operation, each projection unit 132 projects images onto a different portion of the frit region of projection surface 134. In some embodiments, I/O devices includes three projection units 132, where each projection unit 132 projects images onto a portion of the frit region at the bottom of the windshield above the dashboard. An occupant of the vehicle can observe the displayed images by slightly shifting focus from the road ahead to the frit region at the bottom of the windshield. Further, the occupant of the vehicle can observe the displayed images with peripheral vision without shifting focus from the road ahead to the frit region. Projection unit 132 can project images at an angle of incidence and with a type of light that enhances the reflectivity of the light beams projected by projection unit 132, thereby improving the brightness and legibility of the projected images as perceived by the occupant. The dark color of the frit region increases the contrast of the projected images, thereby increasing legibility of the projected images. Further, the dark color of the frit regions causes the frit region to absorb light beams that penetrate the inner surface of the windshield. As a result, the frit region prevents the light beams from reflecting off the outer surface of the windshield, which could otherwise result in ghost images that can reduce the legibility of the projected images. In some embodiments, projection unit 132 projects s-type polarized light at an incidence angle to the frit region that is between 50 degrees and 60 degrees.

In some embodiments, projection surface 134 is nonplanar, such as when projection surface 134 is a windshield that is curved in the horizontal direction and/or the vertical direction. In such embodiments, the frit region of projection surface 134 can likewise be curved. When projection unit 132 projects images onto a curved frit region, the images can be distorted due to this curvature. To reduce or eliminate this distortion, projection surface 134 can modify images prior to projecting the images in order to compensate for the curvature of projection surface 134. For example, a portion of projection surface 134 can be curved in a manner that vertically and/or horizontally compresses a portion of the projected image, as perceived by an occupant viewing the images on projection surface 134. Therefore, projection unit 132 can expand the corresponding portion of the projected image, such that, when displayed on projection surface 134, the occupant perceives an undistorted image. Similarly, a portion of projection surface 134 can be curved in a manner that vertically and/or horizontally expands a portion of the projected image, as perceived by an occupant viewing the images on projection surface 134. Therefore, projection unit 132 can compress the corresponding portion of the projected image, such that, when displayed on projection surface 134, the occupant perceives an undistorted image.

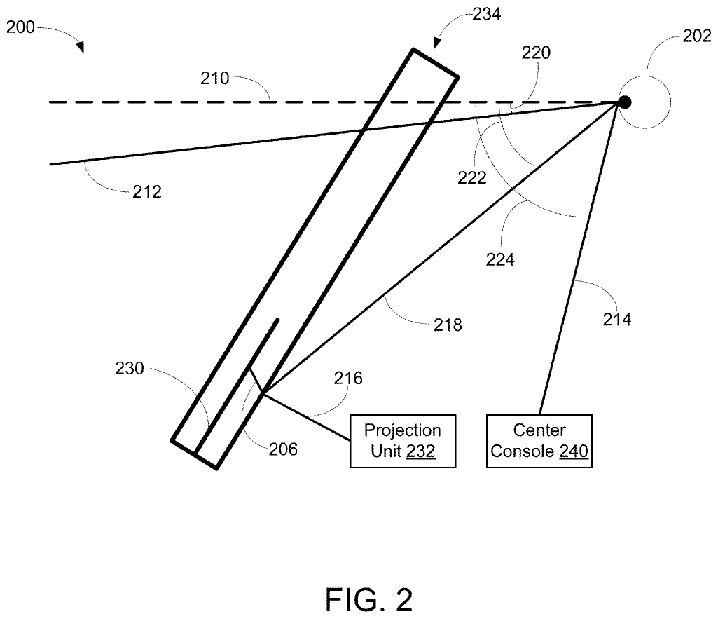

FIG. 2 illustrates a content display arrangement 200 implemented in a vehicle with the projection display system of FIG. 1, according to various embodiments. As shown, display arrangement 200 includes a projection unit 232 of a projection display system (e.g., projection display system 100). In some embodiments, projection unit 232 is installed or mounted on top of a dashboard of a vehicle, or inside the dashboard but exposed to the top of the dashboard, such as by using one or more mirrors (not shown). Projection unit 232 can project a light beam 216 carrying an image for display, toward a frit region 230 (e.g., bottom edge of windshield directly exposed to the vehicle cabin) of a projection surface 234 (e.g., a windshield of the vehicle). Projection surface 234 reflects a portion of light beam 216 off the interior surface of projection surface 234 and redirects the reflected light beam 218 toward one or more eye(s) 202 of a user (e.g., a vehicle occupant). The user receiving light beam 218 perceives the corresponding image as coming from a location on or near frit region 230 of projection surface 234. Further, a portion of light beam 216 can penetrate the inner surface of projection surface 234 and be refracted, as shown by light beam 206. Refracted light beam 206 is directed towards frit region 230. Frit region 230 absorbs, or partially absorbs, the light beam 206, thereby preventing the light beam 206 from reflecting off the outer surface of projection surface 234. Light beam 206 also carries the image for display. Due to the refraction of light beam 206, if light beam 206 reflected off the outer surface of projection surface 134, light beam 206 could result in a ghost image as perceived by the user. The ghost image can reduce the legibility of the projected images. Instead, frit region 230 absorbs, or partially absorbs, the refracted light beam 206, thereby reducing or eliminating such ghost images.

In addition, some of the content projected by projection unit 232 can be duplicated and presented on a center console 240. A vehicle occupant view the duplicated content presented on the center console 240, in addition to, or as an alternative to, viewing the content on frit region 230. When one or more eye(s) 202 of the vehicle occupant are focused on the road ahead, the eye(s) 202 can focus along path 212 through the transparent portion of projection surface 234. In some embodiments, the angle 220 of path 212 can be approximately 2 to 3 degrees below a horizontal plane 210. When one or more eye(s) 202 of the vehicle occupant are focused on the images projected by projection unit 232, the eye(s) 202 can focus along a path coincident with light beam 218 reflected off frit region 230 of a projection surface 234. In some embodiments, the angle 222 of light beam 218 can be approximately 9 to 10 degrees below horizontal plane 210. By contrast, when one or more eye(s) 202 of the vehicle occupant are focused on the images displayed on center console 240, the eye(s) 202 can focus along path 214. In some embodiments, the angle 224 of path 214 can be approximately 16 to 18 degrees below horizontal plane 210. Consequently, the focus of the vehicle occupant when viewing images projected by projection unit 232 is closer to the focus of the vehicle occupant along path 212 through the transparent portion of projection surface 234, relative to when the vehicle occupant observes content displayed on center console 240 along path 214.

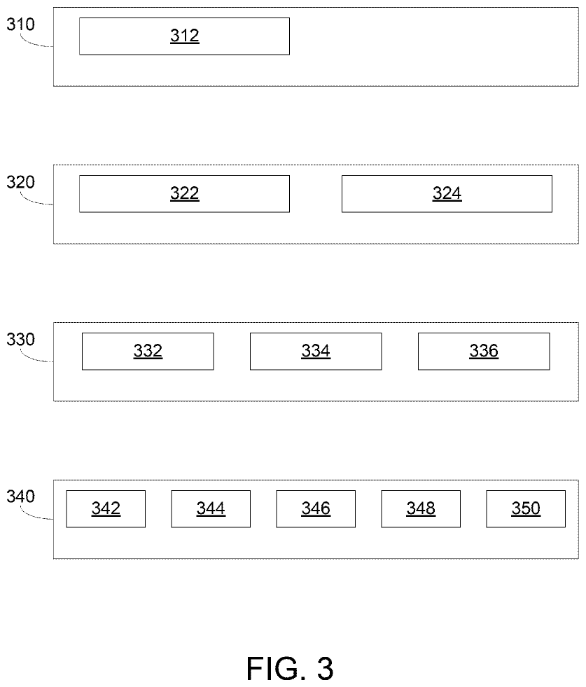

FIG. 3 illustrates display arrangements associated with the projection units 132 of FIG. 1, according to various embodiments. As described herein, the disclosed techniques can accommodate an arrangement any number of three projection units 132. In that regard, the projection display system 100 can have one projection unit 132 that projects images onto a single display region 312 in the left portion of the frit region 310. Alternatively, the projection display system 100 can have two projection units 132. A first projection unit 132 can project images onto a display region 322 in the left portion of the frit region 320, and a second projection unit 132 can project images onto a display region 324 in the right portion of the frit region 320. Alternatively, the projection display system 100 can have three projection units 132 that project images onto three display regions, a first display region 332 in the left portion of the frit region 330, a second display region 334 in the center portion of the frit region 330, and a third display region 336 in the right portion of the frit region 330. Alternatively, the projection display system 100 can have five projection units 132 that project images onto five display regions 342, 344, 346, 348, and 350 in respective portions of the frit region 340.

In some embodiments, the projection units 132 can be mounted into recesses in a housing (not shown). The housing can include a recess for each projection unit 132 that is mounted to the housing. The housing can further include a dash pad located between the recess(es)and the windshield. When mounted to the recess(es), the projection unit(s) 132 project different images in the direction of the dash pad and onto different portions of the frit region at the bottom of the windshield. Note that the display arrangements illustrated in FIG. 3 are exemplary, and other alternative display arrangements are possible. More generally, the projection display system 100 can accommodate any number and arrangement of projection units 132 and, correspondingly, any number and arrangement of display regions, within the scope of the present disclosure.

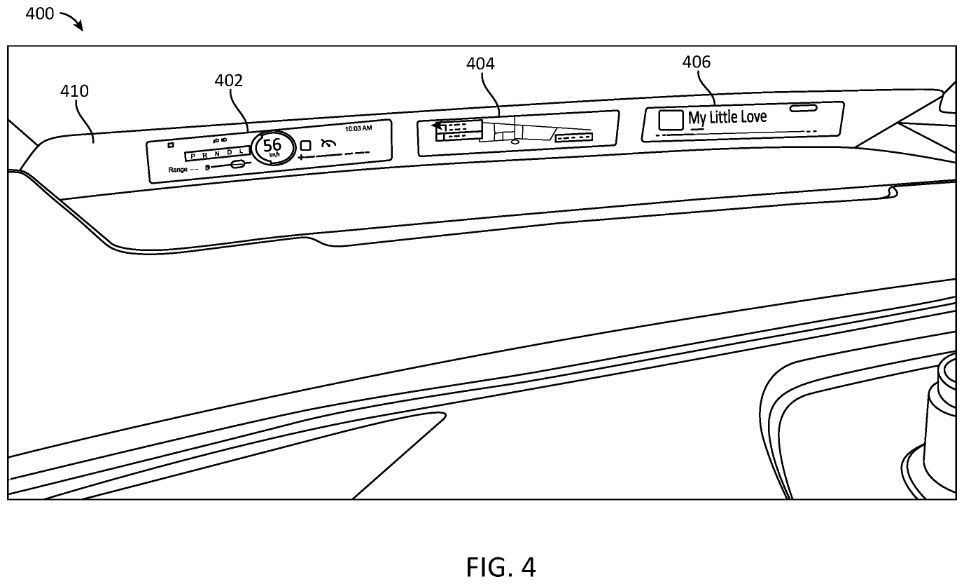

FIG. 4 illustrates content 400 displayed on one or more portions of a projection surface by the projection units of FIG. 1, according to various embodiments. As shown, the content 400 is projected onto the frit region 410 at the lower portion of the windshield. The content 400 is divided into a first image 402 projected by a first projection unit 132, a second image 404 projected by a second projection unit 132, and a third image 406 projected by a third projection unit 132. The three projection units 132 are not shown in FIG. 4.

As shown, first image 402 is projected onto the left portion of the frit region 410. First image 402 is a driver information panel that displays, among other things and without limitation, the transmission gear, the current speed, the fuel level, the water temperature, a bright/dim indicator, time of day, and/or the like. Second image 404 is projected onto the center portion of the frit region 410. Second image 404 is a navigation panel that displays, among other things and without limitation, a map of the area surrounding the vehicle, a graphic showing the next navigation action, current driving conditions, and/or the like. Third image 406 is projected onto the right portion of the frit region 410. Third image 406 is an infotainment panel that displays, among other things and without limitation, the song name, the artist name, cover art, playback controls, a graphic showing playback progress, and/or the like.

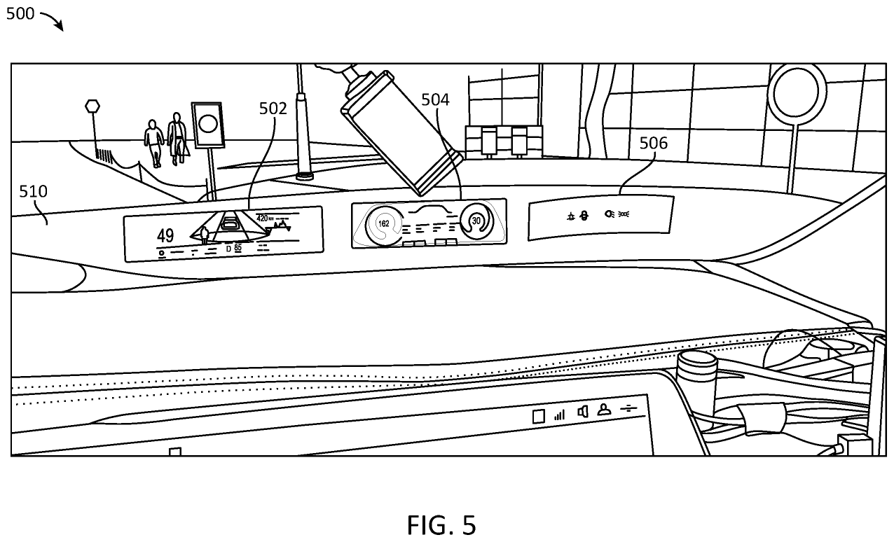

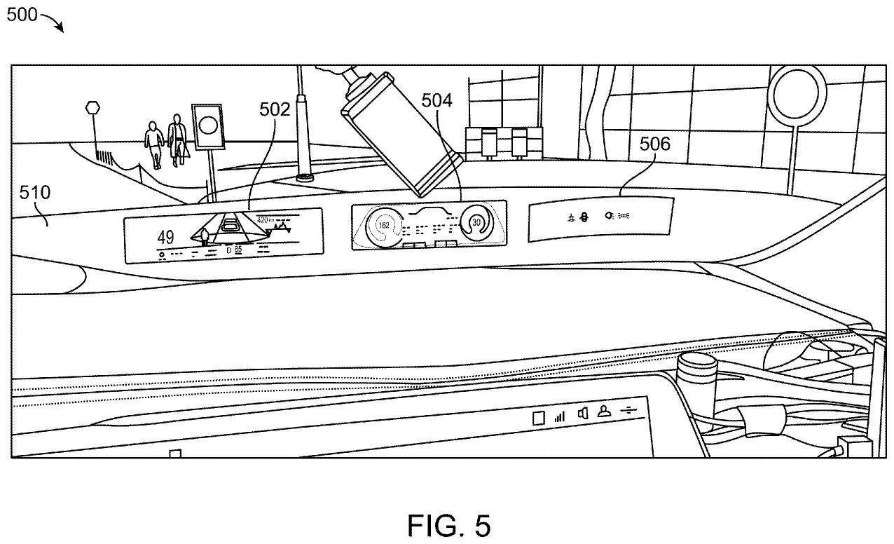

FIG. 5 illustrates content 500 displayed on one or more portions of a projection surface by the projection units of FIG. 1, according to various other embodiments. During vehicle operation, an occupant can change a projection mode from one set of projected displays to a different set of projected displays. In various embodiments, when an occupant changes the projection mode, the images displayed by one projection unit 132 can change. Alternatively, the images displayed by two projection units 132 can change. Alternatively, the images displayed by all three projection units 132 can change. As shown, the content 500 is projected onto the frit region 510 at the lower portion of the windshield. The content 500 is divided into a first image 502 projected by a first projection unit 132, a second image 504 projected by a second projection unit 132, and a third image 506 projected by a third projection unit 132. The three projection units 132 are not shown in FIG. 5.

As shown, first image 502 is projected onto the left portion of the frit region 510. First image 502 is a driver information panel that displays, among other things and without limitation, the current speed, a graphic showing vehicles and pedestrians nearby the vehicle, and/or the like. Second image 504 is projected onto the center portion of the frit region 510. Second image 504 is an environmental control panel that displays, among other things and without limitation, interior temperature, vent controls, air conditioning indicator, and/or the like. Third image 506 is projected onto the right portion of the frit region 510. Third image 506 is a status panel that displays, among other things and without limitation, a check engine indicator, a brake indicator, a fog light indicator, an air bag enabled indicator, and/or the like. The various panels shown in FIGS. 4 and 5, along with other images for different panels (not shown), can be projected onto the frit region 510 in any combination.

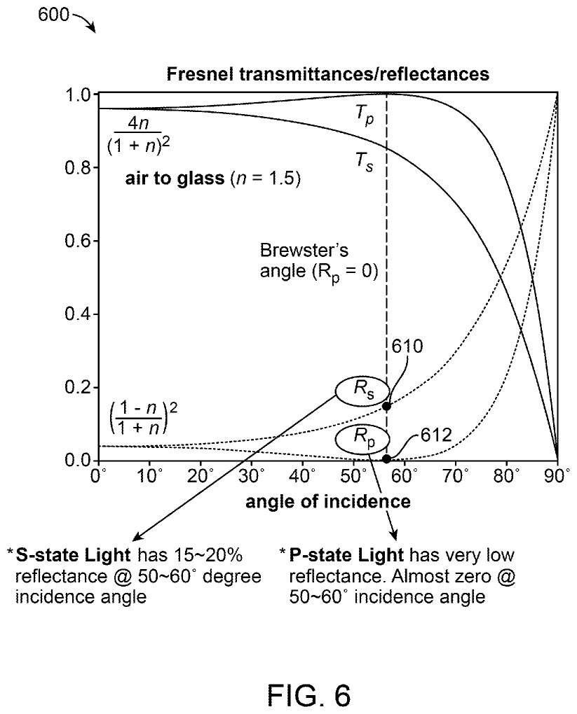

FIG. 6 illustrates a graph 600 of transmittance and reflectance characteristics of S-state polarized light and P-state polarized light, according to various other embodiments. S-state polarized light and P-state polarized light are orthogonal to one another. S-state polarized light is polarized perpendicular to the plane of incidence, while P-state polarized light is polarized parallel to the plane of incidence.

As shown in graph 600, S-state polarized light has a higher reflectance than P-state polarized light, at various angles of incidence. As shown, at an angle of incidence of approximately 56 degrees, the reflectance 610 of S-state polarized light is approximately 0.17, while the reflectance 612 of S-state polarized light is approximately 0.0. At an angle of incidence in the range of 50 to 60 degrees, the reflectance of S-state polarized light is in the range of 0.1 to 0.18, while the reflectance 612 of S-state polarized light is approximately 0.0 for the entire range. Consequently, projecting P-state polarized light onto a partially absorptive portion, such as a frit region, of projection surface 134 would result in little or no reflectance of the projected light. As a result, a vehicle occupant would have difficulty perceiving images projected onto the partially absorptive portion of projection surface 134. Instead, projection unit(s) 132 transmit S-state polarized light, where S-state polarized light has a high reflectance relative to P-state polarized light. As a result, a vehicle occupant would be able to better perceive images projected onto the partially absorptive portion of projection surface 134 with S-state polarized light. Advantageously, projection units 132 can project S-state polarized light at an angle of incidence in the range of 50 to 60 degrees, where S-state reflectance is relatively high and P-state reflectance is at or near zero. In addition, because of the higher reflectance of S-state light, images can be projected using S-state light with lower power and intensity than images projected using P-state light.

In addition, projection unit(s) 132 can project images onto the partially absorptive portion of projection surface 134 with lower power than images projected onto the transparent portion of projection surface 134. In some embodiments, in order for projected images to be perceivable, projection unit(s) 132 can project images onto the partially absorptive portion of projection surface 134 with a display intensity in the range of 3,000 nit, where a nit is a unit of brightness equal to one candela per square meter. By contrast, in order for projected images to be perceivable, a heads-up display system typically projects images onto the transparent portion of projection surface 134 with a display intensity in the range of 12,000 nit. As a result, images can be projected by projection unit(s) 132 onto the partially absorptive portion of projection surface 134 with lower intensity light than is typically required by a heads-up display system that projects images onto the transparent portion of projection surface 134. Further, projecting light with higher intensity can result in high power consumption relative to projecting light with lower intensity, which can reduce the MPG of a fuel-powered vehicle, the MPGe of an electric vehicle, and/or the like.

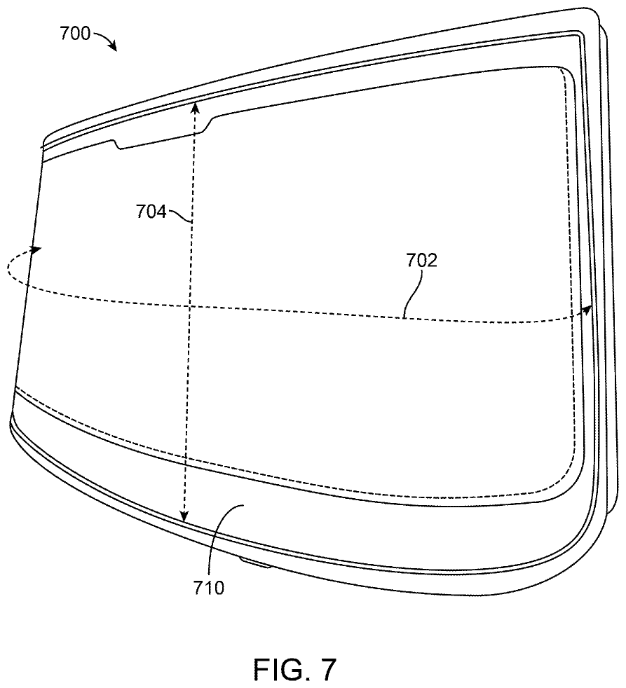

FIG. 7 illustrates curvature of a windshield 700 that includes a frit region 710, according to various other embodiments. As shown, windshield 700 can curve in the horizontal direction as illustrated by horizontal axis 702. Additionally or alternatively, windshield 700 can curve in the vertical direction as illustrated by horizontal axis 704. Such curves in windshield 700 can distort the images projected onto the frit region 710 by projection unit 132. Consequently, projection unit 132 can modify an image prior to projecting the image onto the frit region 710 to compensate for the distortion resulting from the curve in windshield 700.

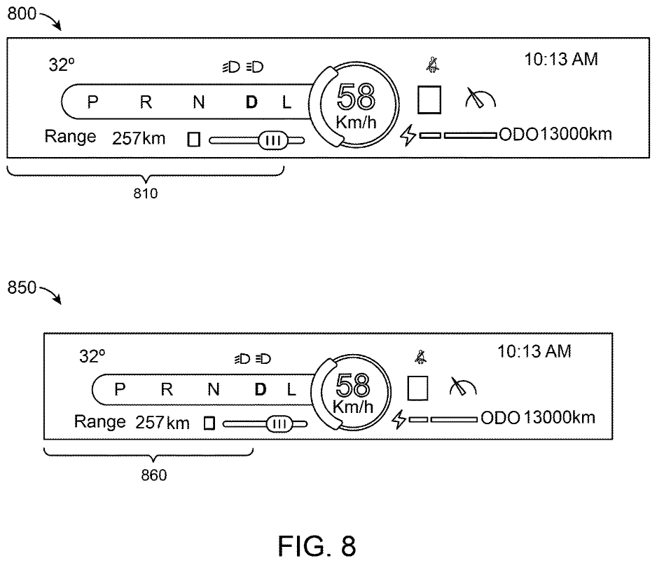

FIG. 8 illustrates modification of content to compensate for curvature of the windshield of FIG. 7, according to various other embodiments. As shown, modified image 800 includes a region 810 to the left of image 800 that is expanded. Projection unit 132 generates modified image 800 with expanded region 810 in order to compensate for a curvature in the corresponding portion of frit region 710 that optically compresses that portion of the image. Projected image 850 illustrates the modified image 800 after being projected onto frit region 710. Frit region 710 optically compresses region 810 of modified image 800 such that, after being projected onto frit region 710, the occupant perceives projected image 850 including region 860 with correct scaling.

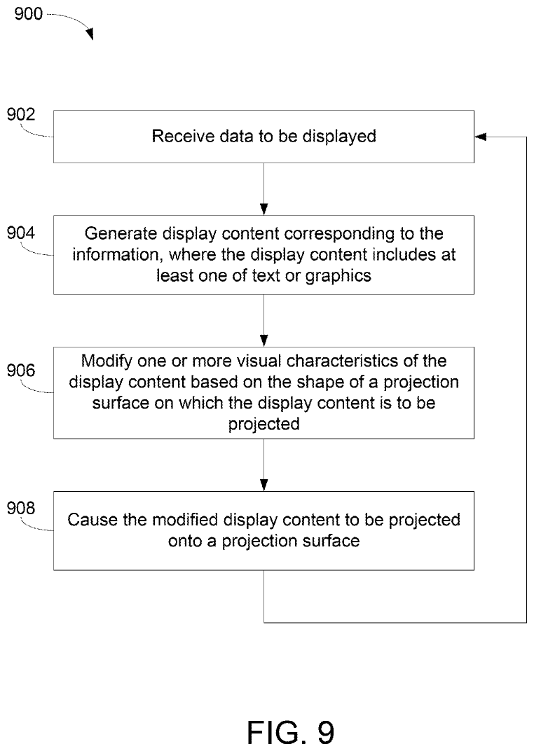

FIG. 9 is a flow diagram of method steps for displaying content via the projection display system 100 of FIG. 1, according to various embodiments. Although the method steps are described with respect to the systems and embodiments of FIGS. 1 through 8, persons skilled in the art will understand that any system configured to perform the method steps, in any order, falls within the scope of the various embodiments.

As shown, a method 900 begins at step 902, where projection application 150 receives data to be displayed. Projection application 150 can receive data for display from any suitable system or device. For example, projection application 150 can receive (e.g., have transmitted to projection application 150) navigation data (e.g., current road, current speed, speed limit, next turn, etc.) from a navigation system or device. Additionally or alternatively, projection application 150 can receive (e.g., have transmitted to projection application 150) vehicle data (e.g., current speed, water temperature, current gear, fuel level, etc.) from various sensors located in the vehicle. Additionally or alternatively, projection application 150 can receive (e.g., have transmitted to projection application 150) infotainment data (e.g., a title, artist, and cover art, etc. for an audio track being played back) from an infotainment system. Additionally or alternatively, projection application 150 can receive any other relevant data for display.

At step 904, projection application 150 generates display content corresponding to the information, where the display content includes at least one of text or graphics. Projection application 150 generates one or more images to be projected by projection unit(s) 132 onto a partially absorptive portion, such as a frit region, of a projection surface 134. Projection application 150 formats and presents (e.g., visualizes) the generated images based on the data received in step 902, and can include text and/or graphics to present the data. Projection application 150 can generate the images by retrieving one or more display elements and templates from database(s) 142 and arranging the display elements within the template to present the information. For example, the template could be a template for presenting navigation data, and design elements of the template could include graphics for indicating turns and speed limits, as well as a text font or typeface for use with the template. Additionally or alternatively, the template could be a template for presenting vehicle data, and design elements of the template could include graphics for indicating current speed, water temperature, current gear, fuel level, etc., as well as a text font or typeface for use with the template. Additionally or alternatively, the template could be a template for presenting infotainment data, and design elements of the template could include graphics for indicating title, artist, and cover art, etc., as well as a text font or typeface for use with the template.

At step 906, projection application 150 modifies one or more visual characteristics of the display content based on the shape of a projection surface 134 on which the display content is to be projected. Projection surface 134 can curve in the horizontal direction and/or can curve in the vertical direction. Such curves in projection surface 134 can distort the images generated by projection application 150 and projected onto a frit region of projection surface 134 by projection unit 132. Consequently, projection unit 132 can modify an image prior to projecting the image onto the frit region to compensate for the distortion resulting from the curve in projection surface 134. Projection application 150 can include (e.g., insert) the modified content in the content generated in step 904.

In some embodiments, a display element retrieved from a repository of display elements in database 142 can already have such modifications pre-designed into the display element. In such cases, projection application 150 can use that display element without further modification. In some embodiments, database 142 can have multiple versions of the display element, with different amount(s) and/or type(s) of visual characteristics already applied. Projection application 150 can select a version based on one or more parameters and/or criteria and use that version with or without further modification. Projection application 150 can include (e.g., insert) the pre-modified display element or content into the content generated in step 904.

At step 908, projection application 150 causes the modified display content to be projected onto projection surface 134. Projection application 150 projects modified images, via projection unit(s) 132, onto projection surface 134. Projection surface 134 would redirect the projected images to the eyes of a user. The method 900 returns to step 902 to generate further display content corresponding to input data.

In sum, a projection display system generates display content in the form of one or more images that one or more projection units project onto a partially absorptive portion of a projection surface. In some embodiments, the projection surface is a windshield of a vehicle, and the partially absorptive portion is a frit region of the windshield. To display the images, the projection units project light onto the partially absorptive portion. The projection units can project light onto the partially absorptive portion at angle of incidence and of a type of light that increases the reflectance of the light, thereby improving the brightness and legibility of the projected images as perceived by the occupant. Further, the projection units can modify the images prior to projection to compensate for distortion resulting from curves in the projection surface.

At least one technical advantage of the disclosed approaches relative to the prior art is that, with the disclosed techniques, the angle and distance between the view of the road ahead and the view of displayed content is reduced relative to conventional systems that present content on a console display. As a result, the level of distraction experienced by an occupant when viewing the displayed content is reduced relative to systems with console displays. Another advantage of the disclosed approaches relative to the prior art is that the amount of power needed to project content for display on a partially absorptive surface of the windshield is reduced relative to heads-up display systems, leading to improved mileage performance. These technical advantages provide one or more technological improvements over prior art approaches.

1. In some embodiments, a computer-implemented method comprises: receiving data associated with a vehicle; generating, based on the received data, content for display on a projection surface comprising a partially absorptive portion and a transparent portion, wherein the partially absorptive portion is located along one or more border regions of the projection surface and the transparent portion is located in a central region of the projection surface; and projecting the content onto the partially absorptive portion of the projection surface.

2. The computer-implemented method of clause 1, wherein projecting the content onto the partially absorptive portion of the projection surface comprises projecting the content onto the projection surface at an incidence angle between 50 degrees and 60 degrees.

3. The computer-implemented method of clauses 1 or 2, wherein projecting the content onto the partially absorptive portion of the projection surface comprises projecting s-state polarized light.

4. The computer-implemented method of any of clauses 1-3, wherein light for projecting the content onto the partially absorptive portion of the projection surface is of lower intensity than light needed to display the content on the transparent portion of the projection surface.

5. The computer-implemented method of any of clauses 1-4, wherein the content projected onto the partially absorptive portion is viewable by an occupant of the vehicle at an angle approximately 9 to 10 degrees below a horizontal plane.

6. The computer-implemented method of any of clauses 1-5, wherein projecting the content onto the partially absorptive portion of the projection surface comprises: projecting a first portion of the content onto a first location on the partially absorptive portion of the projection surface via a first projection unit; and projecting a second portion of the content onto a second location on the partially absorptive portion of the projection surface via a second projection unit.

7. The computer-implemented method of any of clauses 1-6, wherein the partially absorptive portion comprises a frit region of the projection surface.

8. The computer-implemented method of any of clauses 1-7, wherein the frit region is black.

9. The computer-implemented method of any of clauses 1-8, wherein the projection surface is a windshield of the vehicle.

10. The computer-implemented method of any of clauses 1-9, further comprising, prior to projecting the content onto the partially absorptive portion of the projection surface, modifying the content based on a curvature of the projection surface.

11. In some embodiments, one or more non-transitory computer-readable storage media include instructions that, when executed by one or more processors, cause the one or more processors to perform steps of: receiving data associated with a vehicle; generating, based on the received data, content for display on a projection surface comprising a partially absorptive portion and a transparent portion, wherein the partially absorptive portion is located along one or more border regions of the projection surface and the transparent portion is located in a central region of the projection surface; and projecting the content onto the partially absorptive portion of the projection surface.

12. The one or more non-transitory computer-readable storage media of clause 11, wherein projecting the content onto the partially absorptive portion of the projection surface comprises projecting the content onto the projection surface at an incidence angle between 50 degrees and 60 degrees.

13. The one or more non-transitory computer-readable storage media of clauses 11 or 12, wherein projecting the content onto the partially absorptive portion of the projection surface comprises projecting s-state polarized light.

14. The one or more non-transitory computer-readable storage media of any of clauses 11-13, wherein projecting the content onto the partially absorptive portion of the projection surface comprises: projecting a first portion of the content onto a first location on the partially absorptive portion of the projection surface via a first projection unit; and projecting a second portion of the content onto a second location on the partially absorptive portion of the projection surface via a second projection unit.

15. The one or more non-transitory computer-readable storage media of any of clauses 11-14, wherein the partially absorptive portion comprises a frit region of the projection surface.

16. In some embodiments, a system comprises: a projection surface comprising a partially absorptive portion and a transparent portion, wherein the partially absorptive portion is located along one or more border regions of the projection surface and the transparent portion is located in a central region of the projection surface; and a first projection unit configured to: receive data associated with a vehicle; generate, based on the received data, content for display on the projection surface; and project the content onto the partially absorptive portion of the projection surface.

17. The system of clause 16, further comprising a housing that includes a dash pad and a first recess, wherein the first projection unit is mounted into the first recess.

18. The system of clauses 16 or 17, further comprising a second projection unit, wherein the second projection unit is mounted into a second recess included in the housing.

19. The system of any of clauses 16-18, wherein the partially absorptive portion of the projection surface is a frit region comprising at least one of ceramic paint or enamel paint.

20. The system of any of clauses 16-19, wherein the frit region is located at least in part in a lower portion of the projection surface.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
receiving data associated with a vehicle;
generating, based on the received data, content for display on a projection surface comprising a partially absorptive portion and a transparent portion, wherein the partially absorptive portion is located along one or more border regions of the projection surface and the transparent portion is located in a central region of the projection surface; and
projecting the content onto the partially absorptive portion of the projection surface.

2. The computer-implemented method of claim 1, wherein projecting the content onto the partially absorptive portion of the projection surface comprises projecting the content onto the projection surface at an incidence angle between 50 degrees and 60 degrees.

3. The computer-implemented method of claim 1, wherein projecting the content onto the partially absorptive portion of the projection surface comprises projecting s-state polarized light.

4. The computer-implemented method of claim 1, wherein light for projecting the content onto the partially absorptive portion of the projection surface is of lower intensity than light needed to display the content on the transparent portion of the projection surface.

5. The computer-implemented method of claim 1, wherein the content projected onto the partially absorptive portion is viewable by an occupant of the vehicle at an angle approximately 9 to 10 degrees below a horizontal plane.

6. The computer-implemented method of claim 1, wherein projecting the content onto the partially absorptive portion of the projection surface comprises:
projecting a first portion of the content onto a first location on the partially absorptive portion of the projection surface via a first projection unit; and
projecting a second portion of the content onto a second location on the partially absorptive portion of the projection surface via a second projection unit.

7. The computer-implemented method of claim 1, wherein the partially absorptive portion comprises a frit region of the projection surface.

8. The computer-implemented method of claim 7, wherein the frit region is black.

9. The computer-implemented method of claim 1, wherein the projection surface is a windshield of the vehicle.

10. The computer-implemented method of claim 1, further comprising, prior to projecting the content onto the partially absorptive portion of the projection surface, modifying the content based on a curvature of the projection surface.

11. One or more non-transitory computer-readable storage media including instructions that, when executed by one or more processors, cause the one or more processors to perform steps of:
receiving data associated with a vehicle;
generating, based on the received data, content for display on a projection surface comprising a partially absorptive portion and a transparent portion, wherein the partially absorptive portion is located along one or more border regions of the projection surface and the transparent portion is located in a central region of the projection surface; and
projecting the content onto the partially absorptive portion of the projection surface.

12. The one or more non-transitory computer-readable storage media of claim 11, wherein projecting the content onto the partially absorptive portion of the projection surface comprises projecting the content onto the projection surface at an incidence angle between 50 degrees and 60 degrees.

13. The one or more non-transitory computer-readable storage media of claim 11, wherein projecting the content onto the partially absorptive portion of the projection surface comprises projecting s-state polarized light.

14. The one or more non-transitory computer-readable storage media of claim 11, wherein projecting the content onto the partially absorptive portion of the projection surface comprises:
projecting a first portion of the content onto a first location on the partially absorptive portion of the projection surface via a first projection unit; and
projecting a second portion of the content onto a second location on the partially absorptive portion of the projection surface via a second projection unit.

15. The one or more non-transitory computer-readable storage media of claim 11, wherein the partially absorptive portion comprises a frit region of the projection surface.

16. A system comprising:
a projection surface comprising a partially absorptive portion and a transparent portion, wherein the partially absorptive portion is located along one or more border regions of the projection surface and the transparent portion is located in a central region of the projection surface; and
a first projection unit configured to:
receive data associated with a vehicle;
generate, based on the received data, content for display on the projection surface; and
project the content onto the partially absorptive portion of the projection surface.

17. The system of claim 16, further comprising a housing that includes a dash pad and a first recess, wherein the first projection unit is mounted into the first recess.

18. The system of claim 17, further comprising a second projection unit, wherein the second projection unit is mounted into a second recess included in the housing.

19. The system of claim 16, wherein the partially absorptive portion of the projection surface is a frit region comprising at least one of ceramic paint or enamel paint.

20. The system of claim 19, wherein the frit region is located at least in part in a lower portion of the projection surface.
